(19) United States
(12) Patent Application Publication
(10) Pub. No.: US 2002/0172106 A1
(43) Pub. Date: Nov. 21, 2002

(54) Apparatus for and method of controlling writing of data when error occurs in an optical drive

(75) Inventors: Joo-Yeup Kim, Gyeonggi-do (KR); Won Kim, Gyeonggi-do (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/147,349

(22) Filed: May 17, 2002

(30) Foreign Application Priority Data
May 19, 2001 (KR) 2001-27487

(51) Int. Cl. G11B 7/085; G11B 7/0045

(52) U.S. Cl. 369/30.24; 369/53.36; 369/53.37; 369/47.11

(57) ABSTRACT

An apparatus for and a method of controlling writing of data in an optical drive which enables the data writing to be restarted at a point where the data writing was stopped due to an error. Data in a buffer is monitored for buffer-under-run and a plurality of servo signals are monitored where the data writing is stopped due to an error. The method includes monitoring for an error while performing writing; checking if a write mode is stopped when an error is detected; storing predetermined data required for restarting the write mode while controlling the write mode of the optical drive to stop, when the write mode is stopped; and restarting the data writing using the stored predetermined data. Accordingly, while performing a writing function, an error is detectable by monitoring the plurality of servo signals and the buffer-under-run, thereby enabling the write mode operation to be controlled more precisely.

### CROSS REFERENCE TO RELATED APPLICATIONS

This application claims the benefit of Korean Application No. 2001-27487 filed May 19, 2001, in the Korean Patent Office, the disclosure of which is incorporated herein by reference.

### BACKGROUND OF THE INVENTION

1. Field of the Invention

The present invention relates to an optical drive, and more particularly, to an apparatus for controlling the writing of data when an error occurs in the optical drive, and a method of controlling the writing of the data in an optical drive when the error occurs.

2. Description of the Related Art

An optical drive is used to record data on or reproduce data from a disc such as a CD or a DVD. When an error occurs during a write mode in the optical drive, the write mode operation is stopped and processed as a failure, and then, corrective measures are taken. In a conventional optical drive, the occurrence of the error is determined by monitoring for buffer-under-run, which generally occurs when the quantity of data stored in a buffer, which is included in the optical drive in order to store data provided by a host computer, decreases below a predetermined level.

FIG. 1 is a flow chart for explaining a conventional method of controlling the writing of data when an error occurs in an optical drive. Referring to FIG. 1, the optical drive is checked to determine whether buffer-under-run occurs in a write mode. If it is determined that the buffer-under-run occurs at operation 102, the optical drive is controlled to stop the write mode at operation 103. Then, a write mode error signal is sent to a host computer to which the optical drive is connected, and data writing is stopped at operation 104.

As described above, in conventional optical drives, the occurrence of errors in the write mode is checked only by monitoring for the presence of the buffer-under-run. Thus, the scope of errors which are detectable is very narrow, making it difficult to properly deal with the errors due to factors other than buffer-under-run.

Further, in the case of conventional optical drives, when an error is detected, a writing mode operation is stopped and processed as a failure, but no operations are performed for normally completing data writing.

### SUMMARY OF THE INVENTION

To solve the above problems, it is a first object of the present invention to provide an apparatus for and a method of controlling data writing in an optical drive, which enables data writing to be reinitiated at a point where the data writing was stopped, even if data writing was stopped in a write mode due to an error, thereby normally completing writing.

It is a second object of the present invention to provide an apparatus for and method of controlling data writing in an optical drive, which detect an error in a write mode by monitoring buffer-under-run and a plurality of servo signals, thereby accurately performing data writing.

Additional objects and advantages of the invention will be set forth in part in the description which follows, and, in part, will be obvious from the description, or may be learned by practice of the invention.

To achieve the above and other objects of the invention, there is provided a method of controlling writing when an error occurs in an optical drive, comprising: monitoring for an error while performing writing; checking if a write mode is stopped when an error is detected; storing predetermined data required for restarting the write mode while controlling the write mode of the optical drive to stop, when the write mode is stopped; and restarting writing using the predetermined data.

To achieve the above and other objects of the invention, there is provided an apparatus for controlling a write mode in an optical drive when an error occurs, comprising: means for monitoring for an error during a write mode operation; means for controlling the storing of predetermined data required for restarting the write mode if it is determined by a signal generated by the monitoring means that the write mode is stopped; and means for controlling the write mode so that the write mode is restarted based on the predetermined data.

### BRIEF DESCRIPTION OF THE DRAWINGS

The above objectives and advantages of the present invention will become more apparent by describing in detail a preferred embodiment thereof with reference to the attached drawings in which:

FIG. 1 is a flow chart for explaining a conventional method of controlling writing when an error occurs in an optical drive;

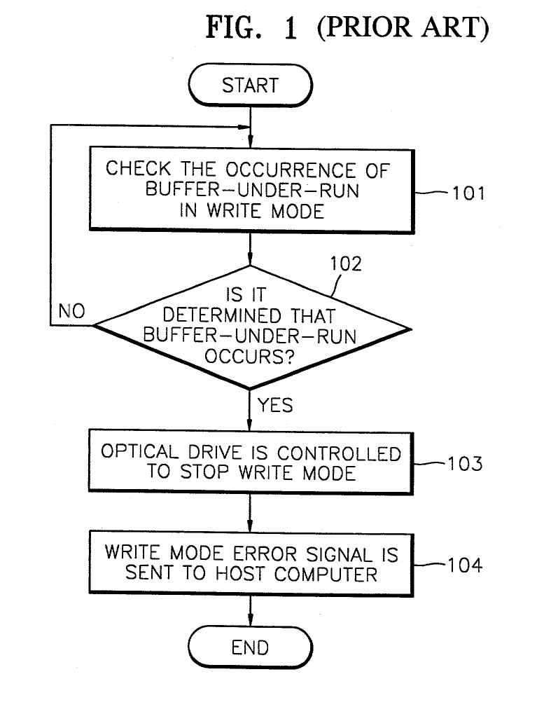

FIG. 2 is a block diagram for explaining the operation of an optical drive according to an embodiment of the present invention; and

FIG. 3 is a flow chart for explaining a method for controlling writing when an error occurs in an optical drive according to the present invention.

### DESCRIPTION OF THE PREFERRED EMBODIMENTS

Reference will now be made in detail to the present embodiments of the present invention, examples of which are illustrated in the accompanying drawings, wherein like reference numerals refer to like elements throughout.

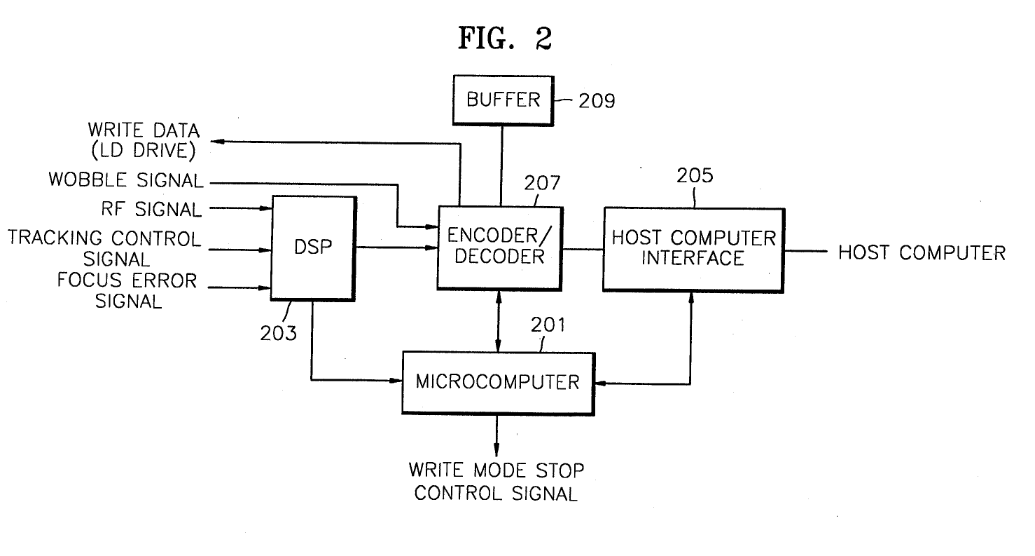

Referring to FIG. 2, an optical drive comprises: a microcomputer 201, a digital signal processor (DSP) 203, a host computer interface 205, an encoder/decoder 207, and a buffer 209. The microcomputer 201 controls writing of data in the optical drive, and the DSP 203 provides servo signals to enable the microcomputer 201 to detect an error in the optical drive in a write mode. The host computer interface 205 connects a host computer (not shown) and the optical drive to exchange data between the host computer and the optical drive. The encoder/decoder 207 stores data provided through the computer interface 205 in the buffer 209, codes or encodes data stored in the buffer 209 to send the data to a disc (not shown), and further, decodes a signal reproduced from the disc (not shown) and processed by the DSP 203 to send the data to the host computer interface 205 and the microcomputer 201. The buffer 209 stores data provided by the encoder/decoder 207 in a write mode.

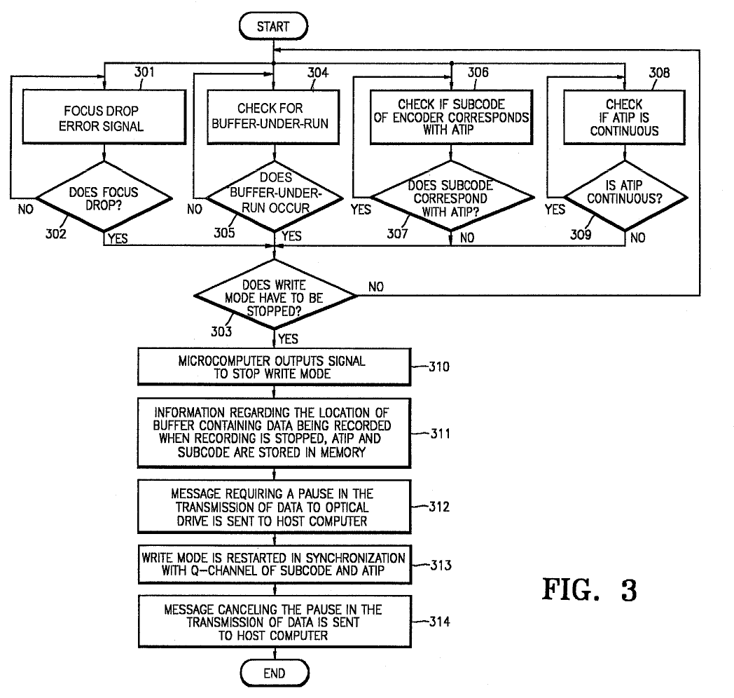

FIG. 3 is a flow chart for explaining a method of controlling data writing according to the present invention where an error occurs in an optical drive. The method will now be explained with reference to FIGS. 2 and 3.

Referring to FIG. 3, a case where writing must be stopped is determined by checking a plurality of different indicators. First, when the optical drive is carrying out a write mode, a focus error signal, which is provided by the DSP 203 and indicates whether a focus drop occurs, is monitored by the microcomputer 201 at operation 301. Then, if the focus is determined to drop at operation 302, the microcomputer 201 checks whether writing must be stopped at operation 303.

Secondly, the microcomputer 201 checks for buffer-under-run via the encoder/decoder 207 at operation 304. If buffer-under-run is confirmed at operation 305, the microcomputer 201 checks whether writing must be stopped at operation 303.

Thirdly, the microcomputer 201 checks whether the subcode of the encoder corresponds to ATIP (absolute time in pregroove) in the encoder/decoder 207 at operation 306. If it is determined that the subcode of the encoder does not correspond to the ATIP at operation 307, the microcomputer 201 checks whether writing must be stopped at operation 303.

Lastly, the microcomputer 201 checks whether the ATIP is continuous at operation 308. If it is determined that the ATIP is not continuous at operation 309, the microcomputer 201 checks whether writing must be stopped at operation 303 (step 303).

Buffer-under-run occurs when the quantity of data stored in the buffer 209 decreases below a predetermined critical value. On occurrence of the buffer-under-run, a subcode of the encoder and the ATIP is checked by the microcomputer 201, reading data stored in the encoder/decoder 207, using a flag or register. The ATIP is detected by a wobble signal picked up from a disc (not shown).

In the case that the result of operation 302 reveals that the focus does not drop, the microcomputer 201 continually monitors for the focus error signal, returning to operation 301. If it is determined in operation 305 that there is no buffer-under-run, the microcomputer 201 continually checks for the buffer-under-run, returning to operation 304. When it is determined in step 307 that the subcode of the encoder and the ATIP correspond, monitoring of the correspondence is continuously carried out, returning to operation 306. Also, if it is determined in operation 309 that the ATIP is continuous, monitoring of the continuity is continuously carried out, returning to operation 308.

The operations 301, 302, and 304 through 308 may be simultaneously performed as shown in FIG. 3, or in an order determined according to the operation of the optical drive.

In operation 303, the microcomputer 201 determines whether the write mode has to be stopped based on the monitoring of the buffer-under-run, a plurality of servo signals such as the focus error signal, and the ATIP, based on the determinations made by operations 301, 302, and 304 through 308. As a result, if the subcode of the encoder 207 corresponds with the ATIP although the ATIP is not continuous, the method returns to operation 301 so that writing is carried out while monitoring for an error through operations 301, 302, and 304 through 309.

However, in the event that the focus drops or the buffer-under-run occurs, the microcomputer 201 outputs a control signal that stops writing in the optical drive even if the subcode of the encoder corresponds with the ATIP at operation 310. Also, if it is determined in operation 309 that the subcode of the encoder does not correspond with the ATIP, a control signal that stops writing in the optical drive is output in operation 310.

Where the writing of the data is randomly performed, the ATIP can be in a discontinuous state, i.e., a “NO” determination at operation 309. However, if the writing of the data is normally performed, the ATIP matches the subcode of the encoder. Although for convenience of explanation of the invention, operations 306 and 308 are separately shown in FIG. 3, both the continuity of the ATIP and the correspondence of the subcode of the encoder must be considered. Therefore, operation 303 of FIG. 3 determines whether the write mode has stopped by considering both the continuity of the ATIP and the correspondence of the subcode of the encoder with the ATIP.

If the writing is stopped at operation 310, the microcomputer 201 stores data regarding the location of the buffer 209 which contains data being recorded, data regarding the ATIP, and subcode data in a memory (not shown) at operation 311, and sends a message, which requires a pause in the transmission of data to the optical drive, to the host computer (not shown) via the host computer interface 205 at operation 312. As a result, the transmission of data for writing is temporarily stopped in the host computer. The subcode data includes, for example, time information when the writing of the data was stopped, a data type, such as for example, audio or video information, track number and CRC.

Then, the microcomputer 201 checks if the error which prompted the pause signal is due to jumping of a track or a subcode in the encoder and controls the optical drive to restart writing at operation 313. That is, when a track is jumped by, e.g., an unstable wobble signal, an unstable tracking control signal or a scratch on the disc, the microcomputer 201 controls the optical drive to restart the writing of the data in consideration of a Q-channel of the subcode. Otherwise, the microcomputer 201 controls the optical drive to restart writing data in consideration of the ATIP when jumping to a subcode is caused by errors in the interface between the host computer and the optical drive.

Lastly, the microcomputer 201 sends a message, which cancels the pause in the transmission of data, to the host computer via the host computer interface 205 at operation 314.

The microcomputer 201 comprises first hardware and/or software which monitors for the occurrence of an error second hardware and/or software which controls the storing of predetermined data and third hardware and/or software which controls the writing of data. The first hardware and/or software monitors at least one servo signal and the occurrence of buffer-under-run in write mode, so that the occurrence of error is checked in the optical drive. The second hardware and/or software determines the temporary stop of writing by a signal from the first hardware and/or software, and controls the optical drive to store predetermined data required for reinitiating writing. The third hardware and/or software controls the optical drive to restart writing according to the predetermined data stored.

As set forth above, in an apparatus and method according to the present invention, when error occurs while data writing is carried out in an optical drive, the data writing is temporarily stopped, the cause of the error is determined and a write mode operation is controlled to restart writing at the point where the writing was stopped. Therefore, writing is normally completed even in the event that an error occurs. For instance, recoding is restarted in consideration of the Q-channel of the subcode of an encoder when a track is jumped due to an unstable wobble signal, an unstable track error signal or a scratch on a disc, and writing is restarted in consideration of the ATIP when jumping to the subcode is caused by an error in the interface between a host computer and the optical drive. Restart is carried out based on time information provided by the Q channel. The time information corresponds to a position where the write mode stopped.

Further, while performing a writing function, an error is detectable by monitoring a plurality of servo signals, as well as monitoring for buffer-under-run, thereby enabling the write mode operation to be controlled more precisely.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of controlling writing when an error occurs in an optical drive, the method comprising:
monitoring for an error while writing data to a disc in the optical drive;
checking whether a write mode is stopped when the error is detected;
storing predetermined data required for restarting the write mode while controlling the write mode of the optical drive to stop, if the write mode is stopped; and
restarting the writing using the predetermined data.

2. The method of claim 1, wherein the monitoring for the error is carried out by monitoring a buffer which stores the data to be written to the disc in the write mode for a presence of less than a minimum quantity of the data to be written to the disc and monitoring at least one servo signal.

3. The method of claim 2, wherein the monitoring of the at least one servo signal comprises:
checking whether a focus drops,
checking whether a subcode of an encoder corresponds with an ATIP, and
checking whether the ATIP is continuous.

4. The method of claim 3, wherein whether the write mode is stopped is determined by whether the ATIP is continuous and whether the subcode of the encoder corresponds with the ATIP.

5. The method of claim 3, wherein in the checking of whether the write mode is stopped, if the subcode of the encoder corresponds with the ATIP although the ATIP is discontinuous, monitoring for the error is continuously carried out while the write mode is not stopped.

6. The method of claim 1, wherein the predetermined data comprises data regarding a location of a buffer in which data for writing is stored, data regarding an ATIP, and subcode data at a point where the write mode is stopped.

7. The method of claim 6, wherein:
when restarting the write mode, the write mode is restarted in consideration of a Q-channel included in the subcode data when the error is caused by a jumping of a track, and
the write mode is restarted in consideration of the ATIP when the error is due to jumping of the subcode of the encoder.

8. The method of claim 1, wherein:
the data to be written to the disc is transmitted from a host computer;
the method further comprises temporarily stopping a transmission of the data for writing from the host computer to the optical drive, after storing the predetermined data, and
the restarting of the write mode further comprises canceling the temporarily stopping of the transmission of data.

9. An apparatus for controlling a write mode in an optical drive when an error occurs, the apparatus comprising:
means for monitoring for an error during a write mode operation;
means for controlling the storing of predetermined data required for restarting the write mode if it is determined by a signal generated by the monitoring means that the write mode is stopped; and
means for controlling the write mode so that the write mode is restarted based on the predetermined data.

10. The apparatus of claim 9, wherein the means for monitoring monitors for an error by monitoring a buffer which stores data to be written to the disc in the write mode for a minimum quantity of the data to be written to the disc and monitoring for at least one servo signal.

11. The apparatus of claim 9, wherein the predetermined data comprises data regarding the location of a buffer in which data for writing is stored, data regarding an ATIP, and subcode data at a point where the write mode is stopped.

12. An apparatus for controlling a writing of data in an optical drive, the apparatus comprising:
a buffer;
a memory;
an encoder which stores data to be written to an optical disc in the optical drive in the buffer;
a microcomputer; which:
controls the writing of the data from the buffer to the optical drive,
determines whether a subcode of the encoder corresponds with an absolute time in pregroove (ATIP); and
stops the writing of the data if the subcode of the encoder does not correspond with the ATIP.

13. The apparatus of claim 12, wherein the microcomputer stores predetermined data in the memory for use in restarting the writing of the data if the writing of the data is stopped.

14. The apparatus of claim 13, wherein the predetermined data comprises:
data regarding a location of the buffer which contains the data to be written;
data regarding an absolute time in pregroove; and
subcode data.

15. An apparatus for controlling a writing of data in an optical drive, the apparatus comprising:
a buffer;
a memory;
an encoder which stores data to be written to an optical disc in the optical drive in the buffer;
a microcomputer; which:
controls the writing of the data from the buffer to the optical drive,
stops the writing of the data on occurrence of one of a predetermined number of errors;
stores predetermined data in the memory for use in restarting the writing of the data if the writing of the data is stopped;
determines whether the occurrence of the one of the predetermined number of errors is due to jumping of a track or a subcode in the encoder; and
restarts the writing of the data based on the stored predetermined data if the writing of the data is stopped due to the jumping of the track or a subcode in the encoder.

16. The apparatus of claim 15, wherein the predetermined data comprises:
data regarding a location of the buffer which contains the data to be written;
data regarding an absolute time in pregroove; and
subcode data.

17. The apparatus of claim 15, wherein the one of the predetermined number of errors is a focus drop error.

18. The apparatus of claim 15, wherein the one of the predetermined number of errors is a mismatch between a subcode of the encoder and an absolute time in pregroove.

19. The apparatus of claim 15, wherein the one of the predetermined number of errors is a buffer-under-run error, where buffer-under-run refers to a determine that the buffer is storing less than a minimum quantity of the data to be written to the optical disc.

20. The apparatus of claim 15, further comprising a host computer interface which interfaces the encoder and the microcomputer with a host computer.

21. The apparatus of claim 20, wherein the microcomputer sends a pause signal to the host computer to pause a transmission of the data to be written if the microcomputer stops the writing of the data on occurrence of the one of a predetermined number of errors.

22. The apparatus of claim 21, wherein the microcomputer sends a cancel signal to the host computer to cancel the pause in the transmission of the data to be written if the microcomputer determines that the occurrence of the one of the predetermined number of errors is due to the jumping of the track or the subcode in the encoder.

23. A method of controlling a writing of data in an optical drive having a buffer which temporarily stores data provided by a host computer, the method comprising:
determining whether a subcode of the encoder corresponds with an absolute time in pregroove (ATIP); and
stopping the writing of the data if the subcode of the encoder does not correspond with the ATIP.

24. The method of claim 23, further comprising:
storing data regarding a location of the buffer which contains the data to be written, data regarding an absolute time in pregroove, and subcode data.

25. A method of controlling a writing of data in an optical drive having a buffer which temporarily stores data transmitted by a host computer and an encoder which stores the data from the host computer in the buffer, the method comprising;
transmitting the data from the host computer to the buffer;
writing the data from the buffer to a disc installed in the disc drive;
stopping the writing of the data on occurrence of one of a predetermined number of errors;
storing predetermined data for use in restarting the writing of the data if the writing of the data is stopped;
determining whether the occurrence of the one of the predetermined number of errors is due to jumping of a track or a subcode in the encoder; and
restarting the writing of the data based on the stored predetermined data if the writing of the data is stopped due to the jumping of the track or the subcode in the encoder.

26. The method of claim 25, wherein the storing of the predetermined data comprises:
storing data regarding a location of the buffer which contains the data to be written;
storing data regarding an absolute time in pregroove; and
storing subcode data.

27. The method of claim 25, further comprising:
stopping the writing of the data on the occurrence of focus drop error.

28. The method of claim 25, further comprising:
stopping the writing of the data on the occurrence of a mismatch between a subcode of the encoder and an absolute time in pregroove.

29. The method of claim 25, further comprising:
stopping the writing of the data on the occurrence of a buffer-under-run, where buffer-under-run refers to a presence in the buffer of less than a minimum quantity of the data provided by the host computer.

30. The method of claim 25, further comprising:
sending a pause signal to the host computer to pause a transmission of the data to be written if the writing of the data is stopped on the occurrence of the one of the predetermined number of errors.

31. The method of claim 30, further comprising:
determining if the one of the predetermined number of errors is due to a jumping of a track or a subcode in the encoder; and
sending a cancel signal to the host computer to cancel the pause in the transmission of the data to be written if the determination is made that the occurrence of the one of the predetermined number of errors is due to the jumping of the track or the subcode in the encoder.
